(19) United States
(12) Patent Application Publication
(10) Pub. No.: US 2021/0243327 A1
(43) Pub. Date: Aug. 5, 2021

(54) IMAGE PROCESSING APPARATUS

(71) Applicant: TOSHIBA TEC KABUSHIKI KAISHA, Tokyo (JP)

(72) Inventor: Masao YAMAGUCHI, Katsushika Tokyo (JP)

(21) Appl. No.: 17/116,946

(22) Filed: Dec. 9, 2020

(30) Foreign Application Priority Data
Feb. 4, 2020 (JP) 2020-016834

(51) Int. Cl. H04N 1/12; H04N 1/00

(52) U.S. Cl. CPC H04N 1/121; H04N 1/0057; H04N 1/00488; H04N 1/00403

(57) ABSTRACT

An image processing apparatus includes an exterior cover, a scanner unit configured to scan an image formed on a sheet, a printer unit configured to form an image on a sheet, and a first speaker including a coil for vibrating a vibration plate. A first part of the exterior cover that covers at least a part of one of the scanner unit or the printer unit forms the vibration plate of the first speaker.

### CROSS-REFERENCE TO RELATED APPLICATIONS

This application is based upon and claims the benefit of priority from Japanese Patent Application No. 2020-016834, filed on Feb. 4, 2020, the entire contents of which are incorporated herein by reference.

### FIELD

Embodiments described herein relate generally to an image processing apparatus.

### BACKGROUND

An image processing apparatus has a speaker for outputting various sounds in response to an input operation made by the operator, an occurrence of a certain error, and the like. Such sounds may reach people other than the operator, and thereby may bother the other people unintentionally. Thus, there is a need for an image processing apparatus capable of suppressing the sounds from reaching people other than the operator.

### BRIEF DESCRIPTION OF THE DRAWINGS

FIG. 1 is a schematic diagram of an image processing apparatus according to an embodiment.

FIG. 2 is a functional diagram of an image processing apparatus according to an embodiment.

FIG. 3 is a schematic diagram of a speaker according to an embodiment.

FIG. 4 is a front view of an image processing apparatus according to an embodiment.

FIG. 5 is a side view of an image processing apparatus according to an embodiment.

### DETAILED DESCRIPTION

An image processing apparatus according to an embodiment includes an exterior cover, a scanner unit configured to scan an image formed on a sheet, a printer unit configured to form an image on a sheet, and a first speaker including a coil for vibrating a vibration plate. A first part of the exterior cover that covers at least a part of one of the scanner unit and the printer unit forms the vibration plate of the first speaker.

Hereinafter, an image processing apparatus according to one or more embodiments will be described with reference to the drawings.

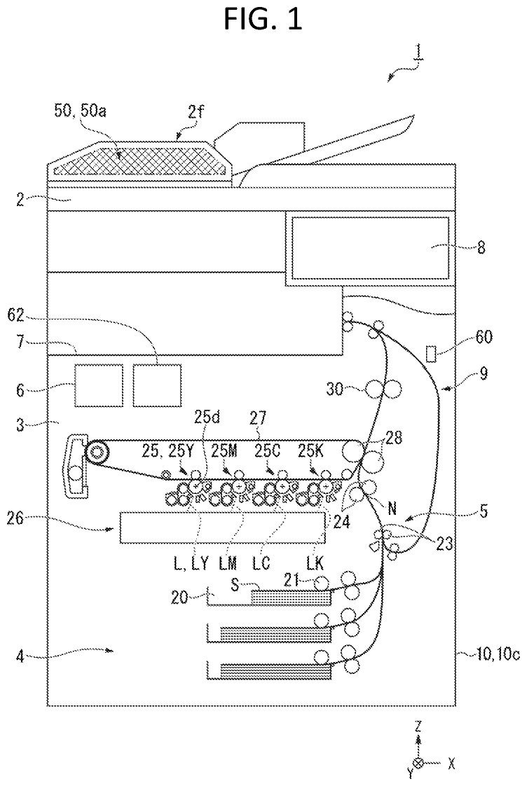

FIG. 1 is a schematic diagram of an image processing apparatus 1 according to an embodiment. For example, the image processing apparatus 1 is an image forming apparatus configured to form an image on a sheet S. The image processing apparatus 1 includes a housing 10, a scanner unit 2, a speaker 50, a printer unit 3, a sheet supply unit 4, a conveyance unit 5, a sheet discharge tray 7, an inversion unit 9, an operation panel 8, and a control unit 6.

The housing 10 houses various parts of the image processing apparatus 1. The housing 10 has a plurality of exterior covers 10c that cover some of the parts of the image processing apparatus 1. The exterior covers 10c are formed of a resin material having a small elastic modulus or the like.

The scanner unit 2 reads an image printed on a target document and generates an image signal. The scanner unit 2 outputs the generated image signal to the printer unit 3. The scanner unit 2 includes an automatic document feeder (ADF) 2f that conveys the document to be read. The automatic document feeder 2f automatically conveys the document from an upper tray to a lower tray through a reading unit of the scanner unit 2.

A speaker 50 outputs a particular sound such as an operation sound or an error sound in response to an input operation made via the operation panel 8. The speaker 50 uses an exterior cover 10c that covers the front surface of the automatic document feeder 2f as a vibration plate. The details of the speaker 50 will be described later.

The printer unit 3 forms an output image (hereinafter referred to as a toner image) by a recording agent such as toner on the basis of the image signal received from the scanner unit 2 or an image signal received from an external device via a network. The printer unit 3 transfers the toner image onto the surface of the sheet S. The printer unit 3 heats and presses the toner image on the surface of the sheet S, and fixes the toner image to the sheet S. The details of the printer unit 3 will be described later.

The sheet supply unit 4 supplies the sheets S one by one to the conveyance unit 5 in accordance with the timing at which the printer unit 3 forms the toner image. The sheet supply unit 4 includes a sheet storage unit 20 and a pickup roller 21.

The sheet storage unit 20 stores the sheets S of a predetermined size and type.

The pickup roller 21 picks up the sheets S one by one from the sheet storage unit 20. The pickup roller 21 supplies the sheet S to the conveyance unit 5.

The conveyance unit 5 conveys the sheet S from the sheet supply unit 4 to the printer unit 3. The conveyance unit 5 includes a conveyance roller pair 23 and a registration roller pair 24.

The conveyance roller pair 23 conveys the sheet S from the pickup roller 21 to the registration roller 24. The conveyance roller pair 23 makes the leading end (sheet edge) of the sheet S in the conveyance direction abut against a nip N of the registration roller pair 24.

The registration roller pair 24 bends the sheet S at the nip N, thereby adjusting the position of the leading end of the sheet S. The registration roller pair 24 conveys the sheet S in accordance with the timing at which the printer unit 3 transfers the toner image to the sheet S.

The printer unit 3 includes a plurality of image forming units 25, a laser scanning unit 26, an intermediate transfer belt 27, a transfer unit 28, and a fixing device 30.

Each of the image forming units 25 includes a photosensitive drum 25d. The image forming unit 25 forms a toner image on the photosensitive drum 25d in accordance with an image signal from the scanner unit 2 or from an external device. The plurality of image forming units 25Y, 25M, 25C, and 25K form toner images of yellow, magenta, cyan, and black toner, respectively.

A charger, a developing device, and the like are disposed around the photosensitive drum 25d. The charger charges the surface of the photosensitive drum 25d. The developing device contains a developer containing one of yellow, magenta, cyan, and black toners. The developing device develops the electrostatic latent image on the photosensitive drum 25d. As a result, a toner image is formed on the photosensitive drum 25d by toner of each color.

The laser scanning unit 26 scans the charged photosensitive drum 25d with the laser light L, and exposes the photosensitive drum 25d. The laser scanning unit 26 exposes the photosensitive drums 25d of the image forming units 25Y, 25M, 25C, and 25K with different laser beams LY, LM, LC, and LK, respectively. Accordingly, the laser scanning unit 26 forms an electrostatic latent image on each of the photosensitive drums 25d.

The toner image on the surface of the photosensitive drum 25d is transferred to the intermediate transfer belt 27 (primary transfer).

The transfer unit 28 transfers the toner image formed on the intermediate transfer belt 27 to the surface of the sheet S (secondary transfer).

The fixing device 30 heats and presses the toner image transferred onto the sheet S, and fixes the toner image to the sheet S.

The inversion unit 9 reverses the sheet S to form an image on the back surface of the sheet S. The inversion unit 9 reverses the sheet S discharged from the fixing device 30 by switchback. The inversion unit 9 conveys the reversed sheet S back toward the registration roller pair 24.

The sheet discharge tray 7 holds a sheet S after an image been formed thereon and then discharged.

The operation panel 8 is an input device for the operator to operate the image processing apparatus 1. The operation panel 8 includes a touch panel and various kinds of hardware keys or buttons.

The control unit 6 controls the components of the image processing apparatus 1.

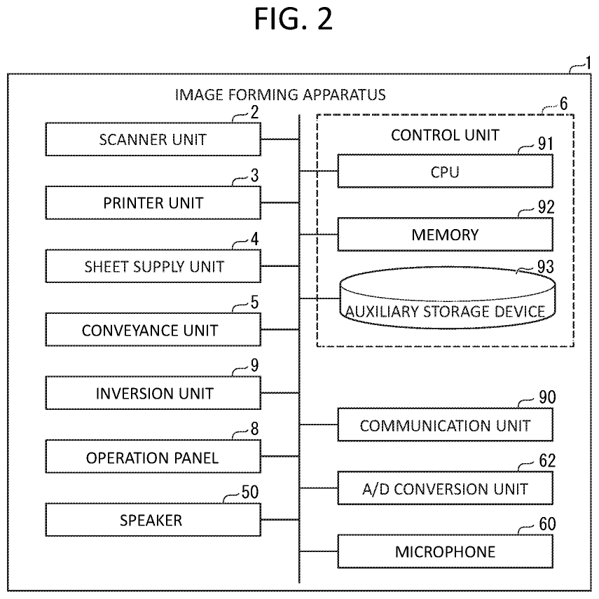

FIG. 2 is a functional diagram of the image processing apparatus 1 according to an embodiment. The image processing apparatus 1 includes: a control unit 6 including a central processing unit (CPU) or a processor 91, a memory 92, and an auxiliary storage device 93; a speaker 50, a microphone 60, an analog/digital (AD) conversion unit 62, and a communication unit 90 connected by a bus, and executes one or more programs. The image processing apparatus 1 controls the scanner unit 2, the printer unit 3, the sheet supply unit 4, the conveyance unit 5, the inversion unit 9, the operation panel 8, the speaker 50, the communication unit 90, and the like, by executing the programs.

The CPU 91 of the control unit 6 executes a program(s) stored in the memory 92 and the auxiliary storage device 93. The control unit 6 controls the operation of each unit of the image processing apparatus 1.

The auxiliary storage device 93 is a storage device such as a magnetic hard disk device (HDD) or a semiconductor storage device. The auxiliary storage device 93 stores various data and programs.

The communication unit 90 is a communication interface circuit for communicating with an external device via a network.

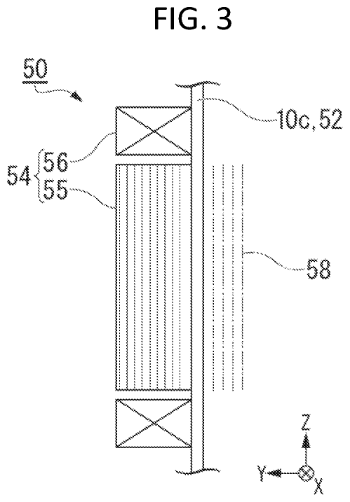

The speaker 50 will be described in detail. FIG. 3 is a schematic diagram of the speaker 50. The speaker 50 outputs a particular sound such as an operation sound or an error sound in response to an operation made via the operation panel 8. The speaker 50 includes a vibration plate 52 and a vibration source 54.

The vibration plate 52 is a part of the exterior cover 10c of the image processing apparatus 1. In other words, a part of the exterior cover 10c of the image processing apparatus 1 is used as the vibration plate 52 of the speaker 50. The vibration plate 52 is formed of a resin material having a small elastic modulus or the like. The vibration plate 52 is formed in a planar shape. The vibration plate 52 is formed in a thin plate shape and has a small elastic modulus, and thus is easily vibrated.

The vibration source 54 is installed behind the vibration plate 52 (i.e., inside of the image processing apparatus 1). The vibration source 54 includes a coil 55 and a magnet 56.

The coil 55 is wound in parallel to the vibration plate 52. The coil 55 is fixed to the rear surface of the vibration plate 52.

The magnet 56 is a permanent magnet fixed to the inside of the image processing apparatus 1. The magnet 56 is arranged along the coil 55. The magnet 56 generates a magnetic field which is parallel to the vibration plate 52 and is orthogonal to the winding of the coil 55.

When the coil 55 disposed in the magnetic field of the magnet 56 is energized, a Lorentz force is generated on the coil 55 in a direction corresponding to Fleming's law. The Lorentz force causes the vibration plate 52 to vibrate in the front-rear direction along with the coil 55. As a result, a sound is output in front of the vibration plate 52.

As described above, a part of the exterior cover 10c of the image processing apparatus 1 is used as the vibration plate 52 of the speaker 50. Accordingly, there is no need to provide a separate speaker in the image processing apparatus 1, and thus the size of the image processing apparatus 1 can be reduced.

Since the vibration plate 52 is formed in a planar shape, the sound output from the vibration plate 52 is a plane wave. The sound of the plane wave travels in a specific direction without spreading substantially in various directions other than along the specific direction. That is, the sound output from the vibration plate 52 primarily travels forward in the direction perpendicular to the vibration plate 52.

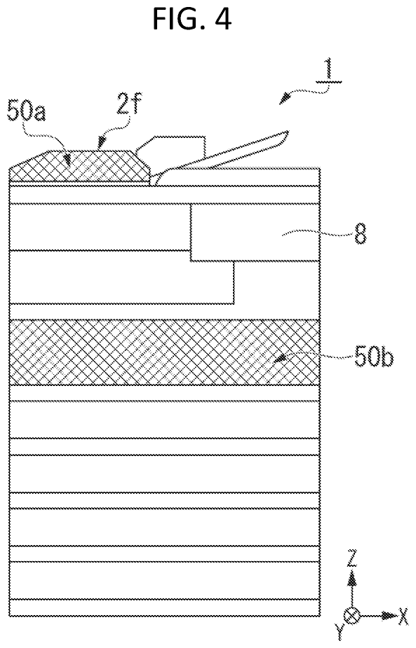

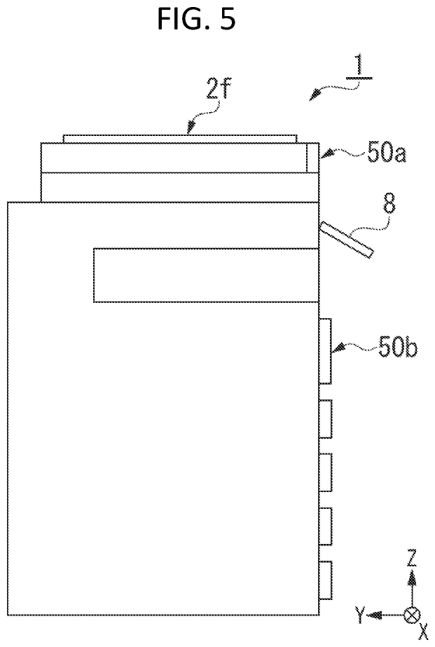

FIG. 4 is a front view of the image processing apparatus 1. FIG. 5 is a side view of the image processing apparatus 1. In one embodiment, the image processing apparatus 1 includes a first speaker 50a and a second speaker 50b. The image processing apparatus 1 may include both of the first speaker 50a and the second speaker 50b, and may have either one of them.

The first speaker 50a is disposed in the automatic document feeder 2f above the operation panel 8. The vibration plate 52 of the first speaker 50a is a part of the exterior cover 10c of the automatic document feeder 2f. The operation panel 8 is installed in the −Y direction of the image processing apparatus 1 in FIG. 4. The vibration plate 52 is a part of the exterior cover 10c facing in the −Y direction.

The second speaker 50b is disposed in a main body of the image processing apparatus 1 below the operation panel 8. The vibration plate 52 of the second speaker 50b is a part of the exterior cover 10c of the body. The vibration plate 52 is a part of the exterior cover 10c facing in the −Y direction. Since the exterior cover 10c of the body portion has a large area, the vibration plate 52 easily vibrates. The second speaker 50b can output a sound at a high volume.

The operation panel 8 is installed on the −Y direction side of the image processing apparatus 1. The operator of the operation panel 8 stands on the −Y direction side of the operation panel 8, faces the operation panel 8, and operates the operation panel 8. The sounds output from the vibration plate 52 of the first speaker 50a and the second speaker 50b travel in the −Y direction with directivity, and reaches the operator. Since the sound output from the vibration plate 52 does not spread, it is unlikely for the sound to reach people other than the operator. A particular sound, such as an error sound, generated in response to an operation made via the operation panel 8, can set to be a relatively unpleasant sound having a large sound pressure and a high frequency, so as to notify or alert the operator. According to the above-described configuration, it is possible to prevent the sound output from the image processing apparatus 1 from giving discomfort to people other than the operator.

The operation panel 8 is disposed facing upward. The operator of the operation panel 8 looks down at the operation panel 8 from above, and operates the operation panel 8 from this position. Since the first speaker 50a is arranged above the operation panel 8, it is relatively close to the ears of the operator. The sound output from the first speaker 50a is likely to be heard by the operator even when the sound pressure is small (that is, the sound is low/quiet). Therefore, it is possible to minimize the volume of the sound output from the first speaker 50a. Accordingly, it is possible to reduce the sounds reaching people other than the operator.

A cancel function of the operation sound of the image processing apparatus 1 will be described.

As shown in FIGS. 1 and 2, the image processing apparatus 1 includes a microphone 60 and an analog-to-digital (A/D) conversion unit 62.

The microphone 60 detects noise/sounds from the image processing apparatus 1. Some of the units of the image processing apparatus 1 are driven by motors. The main operation noise of the image processing apparatus 1 is generated by such motors. Those motors are typically disposed on the +Y direction side inside the image processing apparatus 1. Therefore, the microphone 60 is disposed towards the +Y direction side (i.e., the back surface side) inside the image processing apparatus 1. Among the various operating noises, the noise from operations of the conveyance unit 5 conveying a sheet is also typically large. Therefore, as shown in FIG. 1, the microphone 60 is disposed on the +X direction side inside the image processing apparatus 1 that is in the vicinity of the conveyance unit 5. However, the microphone 60 may be disposed at another position inside the image processing apparatus 1 , or may instead be disposed outside the image processing apparatus 1. The microphone 60 outputs a first signal corresponding to the received operation noise of the image processing apparatus 1.

The A/D conversion unit 62 receives the first signal from the microphone 60. The A/D conversion unit 62 performs signal conversion between an analog signal and a digital signal. The A/D conversion unit 62 converts the first signal, which is an analog signal, into an intermediate signal, which is a digital signal, and outputs this intermediate signal.

The control unit 6 (or the CPU 91) functions to acquire the intermediate signal output from the A/D conversion unit 62. The control unit 6 generates a second signal having a phase opposite to that of the first signal based on the intermediate signal. The generation of the second signal may be performed by a signal processing unit inside or outside of the control unit 6. The control unit 6 outputs the generated second signal to the speaker 50.

Upon receipt of the second signal, a power supply unit of the speaker 50 energizes the coil 55 of the vibration source 54 according to the second signal. Thereby, a sound that cancels the noise corresponding to the first signal (i.e., the noise from the motor) is output from the vibration plate 52.

The cancellation sound is output from the exterior cover 10c. The vibration plate 52 of the speaker 50 is a part of the exterior cover 10c. The operation noise of the image processing apparatus 1 has a phase opposite to the cancellation sound output from the vibration plate 52. As such, at least a part of the operation noise is canceled by the output of the cancellation sound. Therefore, the environmental operation noise of the image processing apparatus 1 is reduced.

The relationship between the magnitude of the operation noise and the magnitude of the first signal corresponding to the operation sound is stored in the control unit 6 in advance. Additionally, the relationship between the magnitude of the second signal and the magnitude of the cancellation sound corresponding to the second signal is stored in the control unit 6 in advance. The control unit 6 may generate the second signal such that the magnitude of the operation noise and the magnitude of the cancellation sound become identical by using those relationships. As a result, a large part of the operation noise can be canceled by the cancellation sound. Therefore, the operation noise of the image processing apparatus 1 is reduced.

As described above, the image processing apparatus 1 includes the vibration plate 52 and the vibration source 54, and the vibration plate 52 is at least a part of the exterior cover 10c. The vibration plate 52 has a planar shape. The vibration source 54 is installed inside the vibration plate 52.

Since the vibration plate 52 has a planar shape, a sound that is output from the vibration plate 52 primarily travels in a specific direction. Since the sound output from the vibration plate 52 does not spread in all direction, it is less likely to reach people other than the operator who is typically present along the specific direction. Accordingly, it is possible to reduce the sound reaching people other than the specific person operating the image processing apparatus 1.

The vibration plate 52 is made of a resin material. Since the resin material has a small elastic modulus, the vibration plate 52 vibrates well. Accordingly, it is possible to output a sound having a sufficient volume from the vibration plate 52.

The image processing apparatus 1 includes the operation panel 8 installed on the −Y direction side thereof. The vibration plate 52 is a part of the exterior cover 10c that is disposed on the −Y direction side of the automatic document feeder 2f above the operation panel 8.

The operator of the operation panel 8 faces the operation panel 8 to operate it. The sound output from the vibration plate 52 disposed in the automatic document feeder 2f above the operation panel 8 travels in the direction of the operator with directivity. Accordingly, it is possible to reduce the sound reaching people other than the operator.

The operator of the operation panel 8 looks down the operation panel 8 from above the operation panel 8. The vibration plate 52 disposed in the automatic document feeder 2f above the operation panel 8 is close to the ears of the operator. Therefore, it is possible to reduce the sound output from the vibration plate 52. Accordingly, it is possible to reduce the sound reaching people other than the operator.

The image processing apparatus 1 includes the operation panel 8 installed on the −Y direction side thereof. The vibration plate 52 is a part of the exterior cover 10c disposed on the −Y direction side of the lower side of the operation panel 8.

The operator of the operation panel 8 faces the operation panel 8 to operate it. The sound output from the vibration plate 52 disposed below the operation panel 8 travels towards the operator with directivity. Accordingly, it is possible to reduce the sound reaching people other than the operator.

Since the exterior cover 10c disposed below the operation panel 8 has a large area, the vibration plate 52 vibrates well. Accordingly, it is possible to output the sound at a sufficient volume from the vibration plate 52.

The image processing apparatus 1 includes the microphone 60 and the control unit 6. The microphone 60 outputs the first signal corresponding to the detected operation noise generated by the image processing apparatus 1. The control unit 6 generates a second signal having a phase opposite to that of the first signal, and outputs the second signal to the speaker 50.

When the vibration source 54 of the speaker 50 is operated by the second signal, a cancellation sound having a phase opposite to that of the operation noise of the image processing apparatus 1 is output from the vibration plate 52. At least a part of the operation noise will be canceled by the cancellation sound. Therefore, the operation noise of the image processing apparatus 1 is reduced.

The image processing apparatus 1 may be a decoloring apparatus. A decoloring apparatus performs a process of decoloring an image formed on a sheet with a decolorable toner.

According to at least one of the above-described embodiments, the exterior cover 10c has a planar vibration plate 52 that is a part of the exterior cover. Accordingly, it is possible to reduce the sound reaching people other than the specific person operating the image processing apparatus 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. An image processing apparatus, comprising:
an exterior cover;
a scanner unit configured to scan an image formed on a sheet;
a printer unit configured to form an image on a sheet; and
a first speaker including a coil for vibrating a vibration plate, wherein
a first part of the exterior cover that covers at least a part of one of the scanner unit and the printer unit is the vibration plate of the first speaker.

2. The image processing apparatus according to claim 1, wherein the first part of the exterior cover is a resin material.

3. The image processing apparatus according to clam 1, further comprising:
a control panel facing in a first direction and configured to receive a user input for operating the scanner unit or the printer unit.

4. The image processing apparatus according to claim 3, wherein the first part of the exterior cover faces in the first direction.

5. The image processing apparatus according to claim 4, wherein the first part of the exterior cover covers a part of the scanner unit.

6. The image processing apparatus according to claim 5, wherein the first part of the exterior cover covers a part of an automatic document feeder of the scanner unit.

7. The image processing apparatus according to claim 3, wherein the first part of the exterior covers faces in a second direction crossing the first direction.

8. The image processing apparatus according to claim 7, wherein the first part of the exterior cover covers a part of the printer unit.

9. The image processing apparatus according to claim 1, further comprising:
a microphone; and
a processor configured to:
acquire a first audio signal from the microphone,
generate a second audio signal that has a phase opposite to the first audio signal, and
control the first speaker to output the second audio signal.

10. The image processing apparatus according to claim 9, wherein the microphone is adjacent to a sheet conveyance unit of the printing unit.

11. The image processing apparatus according to claim 9, wherein the microphone is outside the exterior cover.

12. The image processing apparatus according to claim 1, further comprising:
a second speaker a coil for vibrating a vibration plate, wherein
the first part of the exterior cover covers a part of the scanner unit and is the vibration plate of the first speaker, and
a second part of the exterior cover covers a part of the printer unit and is a vibration plate of the second speaker.

13. The image processing apparatus according to claim 12, wherein both the first and second parts of the exterior cover are a resin material.

14. The image processing apparatus according to claim 12, wherein the first part of the exterior cover faces in a first direction and the second part of the exterior cover faces in a second direction crossing the first direction.

15. The image processing apparatus according to claim 12, wherein the second part of the exterior cover has a larger area than the first part of the exterior cover.

16. The image processing apparatus according to claim 1, wherein the printer unit forms an image on a sheet with decolorable toner.

17. An image forming apparatus, comprising:
a printer unit configured to form an image on a sheet;
a conveyance unit configured to convey the sheet to the printer unit;
an exterior cover covering the printer unit and the conveyance unit; and
a first speaker including a coil for vibrating a vibration plate, wherein
a first part of the exterior cover that covers at least a part of the printer unit is the vibration plate of the first speaker.

18. The image forming apparatus according to claim 17, wherein the first part of the exterior cover is a resin material.

19. The image forming apparatus according to claim 17, further comprising:
a control panel facing in a first direction and configured to receive a user input operation, wherein
the vibration plate is in a plane intersecting the first direction.

20. The image forming apparatus according to claim 17, further comprising:
a microphone; and
a processor configured to:
acquire a first audio signal from the microphone,
generate a second audio signal that has a phase opposite to the first audio signal, and
control the first speaker to output the second audio signal.
